(19) United States
(12) Patent Application Publication
(10) Pub. No.: US 2019/0366617 A1
(43) Pub. Date: Dec. 5, 2019

(54) STRAND PROFILE AND PROCESS FOR PRODUCING A STRAND PROFILE

(71) Applicant: BASF SE, Ludwigshafen am Rhein (DE)

(72) Inventors: Gregor DAUN, Ludwigshafen (DE); Christian KORFF, Lemfoerde (DE); Jan WUCHERPFENNIG, Lemfoerde (DE); Diego Douglas D'AULIGNAC, Ludwigshafen (DE); Reinhard JAKOBI, Ludwigshafen (DE); Helmut SCHUERMANN, Darmstadt (DE)

(73) Assignee: BASF SE, Ludwigshafen am Rhein (DE)

(21) Appl. No.: 16/467,667

(22) PCT Filed: Jan. 10, 2018
(86) PCT No.: PCT/EP2018/050545

§ 371 Date: Jun. 7, 2019

(30) Foreign Application Priority Data
Jan. 10, 2017 (EP) 17150805.4

(51) Int. Cl. B29C 53/12; B29C 70/44; B29C 70/50; F16F 1/366

(52) U.S. Cl. CPC B29C 53/12; B29C 70/446; B29K 2309/08; F16F 1/3665; B29C 70/50

(57) ABSTRACT

A strand profile (10) is proposed. The strand profile (10) extends in a longitudinal extent direction (22), the strand profile (10) having a first layer structure (24) arranged around the longitudinal extent direction (22) and a second layer structure (32) surrounding the first layer structure (24), the first layer structure (24) comprising a first multiplicity of layers (26), each layer (26) of the first layer structure (24) having multiple fibers (28), the second layer structure (32) comprising a second multiplicity of layers (34), each layer (34) of the second layer structure (32) having multiple fibers (36), the fibers (28) of the first multiplicity of layers (28) and the fibers (36) of the second multiplicity of layers (34) each extending in longitudinal extent directions (30, 38), the longitudinal extent directions (30) of the fibers (28) of the first multiplicity of layers (26) and the fibers (36) of the second multiplicity of layers (34) each being oriented at an angle with a magnitude in a range from 30° to 60°, and preferably in a range from 40° to 50°, with respect to the longitudinal extent direction (22) of the strand profile (10), the fibers (28) of the first multiplicity of layers (26) extending relative to the longitudinal extent direction (22) of the strand profile (10) in such a way that, in the presence of setpoint torsional loading of the strand profile (10), said fibers are subjected to longitudinal compressive loading in their longitudinal extent directions (30), the fibers (36) of the second multiplicity of layers (34) extending relative to the longitudinal extent direction (22) of the strand profile (10) in such a way that, in the presence of setpoint torsional loading of the strand profile (10), said fibers are subjected to longitudinal tensile loading in their longitudinal extent directions (38), the longitudinal extent directions (30) of the fibers (28) of adjacent layers (26) of the first multiplicity of layers (26) differing from one another by an angle with a magnitude in a range from 0° to 10°, preferably 2° to 10° and even more preferably 2° to 6°, the longitudinal extent directions (38) of the fibers (36) of adjacent layers (34) of the second multiplicity of layers (34) differing from one another by an angle with a magnitude in a range from 0° to 10°, preferably 2° to 10° and even more preferably 2° to 6°. A process for producing a strand profile (10) is also proposed.

The present invention relates to a strand profile and to a process for producing a strand profile.

Strand profiles are used in numerous technical fields. For example, in the field of automotive engineering, metallic strand profiles are bent into the form of a helical spring. There is however a demand to reduce the weight of bent strand profiles. For example, there is a demand to reduce the weight of springs for motor vehicles in order to thereby reduce the weight of the vehicle as a whole, which in turn can reduce the energy consumption and pollutant emissions of the vehicle.

Weight can be reduced for example through the use of fiber-reinforced materials, so-called fiber composite materials. Fiber-reinforced materials comprise, as main components, fibers as reinforcement material and a matrix system or matrix material into which the fibers are embedded. The fibers are typically based on glass, carbon, aramid, polyacrylonitrile, polyester or polyamide. As a matrix system, use is normally made of thermosetting polymers, for example polyester resins, vinyl ester resins, polyurethane resins or epoxy resins, or thermoplastic polymers, such as polyamides, polypropylenes or polyethylenes.

Various processes are known for producing fiber-reinforced strand profiles. In the typical pultrusion process, the fibers are unrolled from spools, are impregnated or otherwise wetted with the matrix system, are placed into the desired profile form, and are cured. Here, the fibers may themselves form the profile form, or they may be applied to a main body. The process is normally performed continuously by virtue of the workpiece formed by the impregnated fibers being drawn continuously through the installation.

In the case of the so-called filament winding process, the fibers are likewise unrolled from spools and are impregnated or otherwise wetted with the matrix system. In standard form, however, this is a discontinuous process in which a core or main body that is to be encased is rotated, and the fibers are guided onto and wound onto the workpiece by means of an axial back-and-forth movement until the desired thickness of the fiber-plastics layer has been achieved.

The so-called pull winding process constitutes a combination of the pultrusion and filament winding processes. A workpiece in strand form is pulled through the installation whilst fiber spools rotate about the workpiece, the fibers are impregnated or wetted, and the wetted fibers are laid on the workpiece. Here, the wetting may also take place for the first time on the workpiece. The workpiece in strand form may be a preformed main body, for example a tube, though it may also be formed by fibers which are placed into a profile form in a first stage, for example in the pultrusion process.

In general, such strand profiles are produced by virtue of multiple layers which are composed of the composite material being wound around a core. The composite material layers are composed of fibers which are embedded into a polymer matrix. The strand profile thus produced may optionally be encased. Furthermore, the strand profile may be bent, for example into the form of a helical spring.

DE 38 24 933 A1 discloses a tubular, twistable spring element with high specific load capacity, composed of two tubular bodies which are arranged concentrically one inside the other and which are formed from fibers, wires, rods or lamellae running at an angle of between 0° and 90°, wherein the winding directions of the tubular bodies are opposite, and, under torsional loading, aside from the twisting, the inner tubular body expands and the outer tubular body contracts, and the two tubular bodies are supported on one another at least above a defined torsional load. An insulating layer which exhibits limited elasticity is arranged between the tubular bodies; furthermore, the two tubular bodies are connected at their ends to in each case one common force introduction part.

EP 0 145 810 A1 discloses an elastic shaft which is constructed from multiple coaxial layers which are composed of fibers lying parallel, wherein the fibers of adjacent layers cross one another. The shaft may be encapsulated with plastic. Under torsional loading, all of the fibers of the shaft are subjected to tensile or compressive loading. The fiber arrangement may be selected such that the fiber loading is approximately equal throughout independently of the layer diameter.

EP 0 637 700 A2 discloses a spiral spring composed of carbon-fiber-reinforced synthetic resin, having a cord which is wound in spiral fashion and which is composed of carbon-fiber-reinforced synthetic resin, wherein the carbon fibers are oriented at an angle of ±30 to ±60° with respect to the axis of the cord. The ratio of the quantities of carbon fibers A and B is 1.1<A/B<4.0, wherein A is the quantity of carbon fibers that are oriented in the direction in which a compressive force is exerted in the longitudinal direction of the fibers, and B is the quantity of carbon fibers that are oriented in the direction in which a tensile force is exerted in the longitudinal direction of the fibers.

JP 2006-226327 A discloses a helical spring which is produced from fiber-reinforced plastic and in the case of which the spring material has multiple layers of fiber-reinforced plastic with a fiber bundle composed of carbon fibers or carbon fibers impregnated with synthetic resin, which are wound around a straight core at predetermined angles in the same direction with respect to the axial direction of the core.

U.S. Pat. No. 5,603,490 A discloses a fiber-reinforced plastics springs with helical fiber winding and, more specifically, a cylindrical torsion bar or a spiral-shaped tension or compression spring having a core, which is either non-reinforced, reinforced with axial fibers or reinforced with twisted fibers, and having a continuous fiber-reinforced composite sheath which has most or all of its fibers arranged in spiral fashion around the core. The core may be solid or hollow.

The direction of the spiral-shaped winding is selected such that the fibers are placed under stress in a longitudinal direction when the spring is used as intended. A sheath fiber winding pitch angle of approximately 55° is used with a weak and non-reinforced core, whereas greater or smaller pitch angles are used only with cores of sufficient stiffness to resist axial normal stress.

WO 2014/014481 A1 discloses a composite material helical spring which has a helical body which extends along a helix axis. The helical body has a core and a multiplicity of fiber layers which are impregnated with a polymer material. The multiplicity of fiber layers is arranged around the core with different radial spacings from the helix axis. Each of the multiplicity of fiber layers extends around the helix axis at an acute angle with respect to the fiber axis. Each of the multiplicity of fiber layers comprises a number of fibers which is equal to a product of a common base number of fibers multiplied by a positive non-zero integer from a set of positive non-zero integers. The positive non-zero integer of at least one of the multiple fiber layers differs from the positive non-zero integer of at least one other of the multiplicity of fiber layers.

FR 2859735 A1 discloses a spring for motor vehicles which has two or more layers of fibers which are wound in opposite directions around a core.

FR 2602461 A1 discloses a process for producing helical springs which are produced from composite materials.

Despite the advantages that arise from the known strand profiles and processes for the production thereof, there remains, as before, a demand for improvement. In particular, there is a demand to further reduce the weight whilst realizing otherwise identical or even improved qualitative characteristics.

It is therefore the object to further develop known strand profiles and processes for producing strand profiles such that the strand profiles exhibit increased fatigue strength and a reduced shear modulus.

Said object is achieved according to the invention by means of a strand profile and a process having the features of the independent claims. Advantageous refinements are specified in the dependent claims.

An underlying concept of the present invention is based on the realization that the required weight of a strand profile and in particular of a helical spring can, on the material side, be further reduced through the use of materials with a higher shear strength and a lower shear modulus. It is a further underlying concept of the present invention to form the strand profile with a thick-layered structure in which the fibers in a tension direction and the fibers in a compression direction lie together in each case, and in which, within the fiber layers in the tension direction and compression direction, there is a slight layerwise modulation of the fiber angle with respect to the extent direction of the strand profile about a mean angle. The fibers in the tension direction preferably lie at the outside.

A strand profile according to the invention has a profile cross section and extends along an axis, which may possibly also be curved. The direction of the axis is referred to as longitudinal extent direction of the strand profile. The strand profile comprises a first layer structure arranged around the longitudinal extent direction of the strand profile and a second layer structure surrounding the first layer structure. The first layer structure comprises a first multiplicity of layers, each layer of the first layer structure having multiple fibers. The second layer structure comprises a second multiplicity of layers, each layer of the second layer structure having multiple fibers. The fibers of the first multiplicity of layers and the fibers of the second multiplicity of layers extend in each case in longitudinal extent directions of the fibers. The longitudinal extent directions of the fibers of the first multiplicity of layers and the fibers of the second multiplicity of layers are each oriented at an angle with a magnitude in a range from 30° to 60°, and preferably in a range from 40° to 50°, with respect to the longitudinal extent direction of the strand profile. The fibers of the first multiplicity of layers extend relative to the longitudinal extent direction of the strand profile in such a way that, in the presence of setpoint torsional loading of the strand profile, said fibers are subjected to longitudinal compressive loading in their longitudinal extent directions. The fibers of the second multiplicity of layers extend relative to the longitudinal extent direction of the strand profile in such a way that, in the presence of setpoint torsional loading of the strand profile, said fibers are subjected to longitudinal tensile loading in their longitudinal extent directions. The longitudinal extent directions of the fibers of adjacent layers of the first multiplicity of layers differ from one another by an angle with a magnitude in a range from 0° to 10°, preferably 2° to 10° and even more preferably 2° to 6°. The longitudinal extent directions of the fibers of adjacent layers of the second multiplicity of layers differ from one another by an angle with a magnitude in a range from 0° to 10°, preferably 2° to 10° and even more preferably 2° to 6°.

In the context of the present invention, a strand profile is to be understood to mean a workpiece which is formed by winding of fibers, impregnation of the fibers with at least one matrix material, and molding of the fibers to form a predetermined profile. The strand profile is correspondingly produced from at least one fiber composite material. For example, the first layer structure and the second layer structure are produced from different or identical fiber composite materials. In the context of the present invention, the strand profile is in particular a workpiece produced by means of a pultrusion process, filament winding process or pull winding process. it may however also be produced by means of some other process, such as for example the winding-up of pre-impregnated fiber scrims to form tubes. The workpiece may be cut to a particular length beforehand, though it may also be present as tubular material of initially indefinite length. The cross-sectional profile of the workpiece may be constant or variable over the length thereof. The cross-sectional profile is restricted only by the fact that its greatest extent must be smaller than a cross section of a passage bore of a device for producing the strand profile. The workpiece may be hollow or compact.

In the present context, a longitudinal extent direction is to be understood to mean an extent in a direction parallel to the longest dimension of the respective component, such as for example the axis of the strand profile, which may possibly also be curved, or the direction of the fibers.

In the context of the present invention, a layer is to be understood to mean a uniform mass of areal extent with a particular thickness which is considerably smaller than the dimensions that form the areal extent.

In the context of the present invention, a layer structure is to be understood to mean a form or a structure in the case of which multiple layers are arranged one on top of the other.

In the context of the present invention, a fiber is to be understood to mean a flexible, elementary structure which is composed of a fiber material and which has an external fiber form which is thin in relation to its length. The fiber may be (quasi-)endless or of limited length. Without support by an encasing matrix, fibers can, in the longitudinal direction, accommodate no compressive forces but only tensile forces, because they buckle under compressive loading.

In the context of the present invention, torsion is to be understood to mean the actions of a force acting parallel to the base surface and tangentially with respect to the side surface of a body and which twists the strand profile primarily about its longitudinal axis.

In the context of the present invention, setpoint torsional loading is to be understood to mean a stress-compatible loading of the strand profile under torsion. In other words, the loading under torsion acts in a direction of rotation for which the strand profile is designed to be loaded under torsion in this direction of rotation.

Correspondingly, a structure for the strand profile is proposed in which a first layer structure is surrounded to the outside by a second layer structure. Both the first layer structure and the second layer structure are formed from multiple layers arranged one on top of the other. Each of the layers in turn has multiple fibers. Thus, the first layer structure is surrounded by the layers of the second layer structure. Here, the windings or pitches of the fibers of the layers of the first layer structure differ from the windings or pitches relating to the fibers of the layers of the second layer structure. In other words, the fibers of the layers of the first layer structure are of right-handed orientation and the fibers of the layers of the second layer structure are of left-handed orientation, or vice versa. Correspondingly, instead of a so-called fine-layer structure, in which the layers with fibers of different winding are arranged alternately one above the other, a coarse-layer structure is proposed, in which a first arrangement of layers with fibers of identical winding one above the other is provided, and then a second arrangement of layers with fibers of identical winding is provided on said first arrangement, wherein the windings of the fibers of the first arrangement differ from the windings of the fibers of the second arrangement. Such a structure increases the fatigue strength and reduces the shear modulus.

Additionally, the orientations of the fibers of adjacent layers of the respective layer structure differs slightly from one another. In other words, the fibers of the respective layers of the first layer structure are not oriented parallel to one another, but rather intersect at a very acute angle as seen in a plan view of the layers. Likewise, the fibers of the respective layers of the second layer structure are not oriented parallel to one another, but rather intersect at a very acute angle as seen in a plan view of the layers. Such a structure has a crack-stopping action.

The second layer structure may comprise more fibers than the first layer structure. Correspondingly, more fibers that can be subjected to tensile loading are provided than fibers that can be subjected to compressive loading. This may be realized by virtue of the second layer structure comprising more layers than the first layer structure, wherein the number of fibers per layer is identical. By means of such a structure, the strand profile can be subjected to more intense torsional loading.

For example, the number of fibers of the second multiplicity of layers is greater by a factor of 1.5 to 9, preferably 1.5 to 4, particularly preferably 2 to 3, than the number of fibers of the first multiplicity of layers. In this way, a strand profile which can be subjected to particularly high torsional loading is obtained.

The first multiplicity of layers and the second multiplicity of layers may have different fiber volume fractions. The first multiplicity of layers may have a fiber volume fraction of 40% to 70% in relation to the volume of the first layer structure, in order for the fibers which are subjected to compression in the longitudinal direction to be laterally supported in as stiff a material composite as possible, and the second multiplicity of layers may have a fiber volume fraction of 35% to 60% in relation to the volume of the second layer structure, in order for the fibers which are subjected to tension in the longitudinal direction to be protected, in a relatively soft environment, against the propagation of micro-cracks and notching as a result of micro-cracks.

The fibers of the first multiplicity of layers may be embedded into a first matrix material. The fibers of the second multiplicity of layers may be embedded into a second matrix material. Here, the second matrix material differs from the first matrix material. The first matrix material thus has a high stiffness with a tensile modulus of greater than 2.9 GPa, in order to laterally support the fibers which are subjected to compression in the longitudinal direction, whereas the second matrix material exhibits high ductility, in order to stop the possible micro-cracks in the fibers which are subjected to tension in the longitudinal direction.

In the context of the present invention, a matrix material is to be understood to mean any material which is suitable for fixing the fibers in their position after being laid. As matrix material, use is normally made of thermosetting polymers, for example polyester resins, vinyl ester resins, polyurethane resins or epoxy resins, or thermoplastic polymers, such as polyamides, polypropylenes or polyethylenes, which preferably combine a high softening temperature, media resistance, fatigue strength and easy processability.

The fibers of the first multiplicity of layers and the fibers of the second multiplicity of layers may be impregnated with different impregnating agents if the first layer structure is separated from the second layer structure by a layer which is impermeable to the impregnating agents. Such a layer has a crack-stopping action, such that a possible crack in the first layer structure cannot propagate to the second layer structure and vice versa.

In the context of the present invention, an impregnating agent is basically to be understood to mean any matrix material which, by curing, for example by polymerization, leads to the adhesive bonding of the fibers and layers to one another and thus to solidification of the fiber composite material. In the context of the present invention, as impregnating agent, use is made in particular of a monomer-based or polymer-based liquid. In particular, the impregnating agent may be a matrix material which is liquid when processed, such as for example a reactive liquid thermoset system based on, for example, polyurethane, polyester, vinyl ester, epoxy resin, or a reactive thermoplastic system based on caprolactam, polyacrylic, or a thermoplastic melt based on, for example, polypropylene, polyethylene, polyamide.

The fibers of the second layer structure may be formed as rovings with a filament diameter smaller than a filament diameter of the fibers of the first layer structure, because, in this way, higher tensile strengths can be attained in the region of the fibers which are subjected to tensile loading in the longitudinal direction.

In the context of the present invention, a roving is to be understood to mean a a bundle, strand or multi-filament yarn composed of filaments arranged in parallel, that is to say endless fibers. Preferably, in the context of the present invention, filaments produced from glass are combined to form rovings, though other materials may basically also be used in the context of the present invention, such as for example aramid or carbon.

The strand profile may have a core on which the first layer structure is arranged. The core may be an arrangement of twisted fibers, a solid core, an encased solid core, a hollow core or an encased hollow core.

In the context of the present invention, a core is to be understood to mean a component or element which is provided for the laying of the fibers. In other words, a core may be any component or element which has a laying surface on which fibers can be laid.

In the case of twisted fibers, the fibers are twisted together. It is thus basically possible for numerous types of cores to be used in the context of the present invention. Here, the cross section of the core is preferably circular, though may basically be oval, elliptical, polygonal or polygonal with rounded corners. A hollow core reduces the weight in relation to a solid core.

The first layer structure is preferably composed of the first multiplicity of layers, and the second layer structure is preferably composed of the second multiplicity of layers. A particularly enduringly stable strand profile is thus specified.

The strand profile may be bent. A greater variety of forms is thus attained.

The strand profile may be bent into the form of a helical spring. Such a type of helical spring is enduringly stable and is of considerably lower weight than helical springs composed of metal or steel.

The helical spring may have at least a pitch H, a spring diameter D and a pitch angle α, a ratio tan α=H/(π*D) being not greater than 0.22 and preferably not greater than 0.21. Such a specific geometry has proven to be particularly enduringly stable, because the cross section of the strand profile is subjected predominantly to torsional loading and to a lesser extent to bending loading. It is explicitly pointed out that the pitch need not be constant across all of the windings of the helical spring, but rather may vary in different portions of the windings. For example, the pitch of the windings at the outer ends of the helical spring is smaller than in a central region of the helical spring.

The strand profile may be designed as a right-handed compression spring or as a left-handed tension spring. Here, the longitudinal extent directions of the fibers of the first multiplicity of layers are in a right-handed orientation with respect to the longitudinal extent direction of the strand profile at an angle with a magnitude in a range from 40° to 50°, and the longitudinal extent directions of the fibers of the second multiplicity of layers are in a left-handed orientation with respect to the longitudinal extent direction of the strand profile at an angle with a magnitude in a range from 40° to 50°. This combination of the form of the fibers in the first and in the second multiplicity of layers has proven to be particularly effectively subjectable to torsional loading.

Alternatively, the strand profile may be designed as a left-handed compression spring or right-handed tension spring. Here, the longitudinal extent directions of the fibers of the first multiplicity of layers are in a left-handed orientation with respect to the longitudinal extent direction of the strand profile at an angle with a magnitude in a range from 40° to 50°, and the longitudinal extent directions of the fibers of the second multiplicity of layers are in a right-handed orientation with respect to the longitudinal extent direction of the strand profile at an angle with a magnitude in a range from 40° to 50°. This combination of the form of the fibers in the first and in the second multiplicity of layers has proven to be particularly effectively subjectable to torsional loading.

It is preferable if the fibers of the first multiplicity of layers and the fibers of the second multiplicity of layers are glass fibers. Such fibers are particularly easy to process and enduringly stable, and have a high fatigue strength.

In the context of the present invention, a glass fiber is to be understood to mean a long thin fiber composed of glass. To produce these, thin filaments are drawn out of a glass melt.

A process according to the invention for producing a strand profile, preferably a strand profile as described above according to the invention, comprises:
(i) providing a core which, in order to define a longitudinal extent direction of the strand profile, extends in a longitudinal extent direction,
(ii) arranging a first layer structure around the core, the first layer structure being formed from a first multiplicity of layers, each layer of the first layer structure having multiple fibers,
(iii) arranging a second layer structure around the first layer structure, the second layer structure being formed from a second multiplicity of layers, each layer of the second layer structure having multiple fibers, the fibers of the first multiplicity of layers and the fibers of the second multiplicity of layers each extending in longitudinal extent directions, the longitudinal extent directions of the fibers of the first multiplicity of layers and the fibers of the second multiplicity of layers each being oriented at an angle with a magnitude in a range from 30° to 60°, and preferably in a range from 40° to 50°, with respect to the longitudinal extent direction of the strand profile, the fibers of the first multiplicity of layers extending relative to the longitudinal extent direction of the strand profile in such a way that, in the presence of setpoint torsional loading of the strand profile, said fibers are subjected to longitudinal compressive loading in their longitudinal extent directions, the fibers of the second multiplicity of layers extending relative to the longitudinal extent direction of the strand profile in such a way that, in the presence of setpoint torsional loading of the strand profile, said fibers are subjected to longitudinal tensile loading in their longitudinal extent directions, the longitudinal extent directions of the fibers of adjacent layers of the first multiplicity of layers differing from one another by an angle with a magnitude in a range from 0° to 10°, preferably 2° to 10° and even more preferably 2° to 6°, the longitudinal extent directions of the fibers of adjacent layers of the second multiplicity of layers differing from one another by an angle with a magnitude in a range from 0° to 10°, preferably 2° to 10° and even more preferably 2° to 6°, and
(iv) removing the core or leaving the core in the first layer structure.

Correspondingly, a process is proposed for producing the strand profile having a structure in which, in the interior, there is situated a core which, in an outward direction, is surrounded by a first layer structure and, following this, by a second layer structure. Both the first layer structure and the second layer structure are formed from multiple layers arranged one on top of the other. Each of the layers in turn has multiple fibers. The core is thus surrounded, to the outside, firstly by the layers of the first layer structure and then by the layers of the second layer structure. Here, the windings or pitches of the fibers of the layers of the first layer structure differ from the windings or pitches relating to the fibers of the layers of the second layer structure. In other words, the fibers of the layers of the first layer structure are of right-handed orientation and the fibers of the layers of the second layer structure are of left-handed orientation, or vice versa. Correspondingly, instead of a so-called fine-layer structure, in which the layers with fibers of different winding are arranged alternately one above the other, a coarse-layer structure is proposed, in which a first arrangement of layers with fibers of identical winding one above the other is provided, and then a second arrangement of layers with fibers of identical winding is provided on said first arrangement, wherein the windings of the fibers of the first arrangement differ from the windings of the fibers of the second arrangement. Such a structure increases the fatigue strength and reduces the shear modulus.

Additionally, the orientations of the fibers of adjacent layers of the respective layer structure differ slightly from one another. In other words, the fibers of the respective layers of the first layer structure are not oriented parallel to one another, but rather intersect at a very acute angle as seen in a plan view of the layers. Likewise, the fibers of the respective layers of the second layer structure are not oriented parallel to one another, but rather intersect at a very acute angle as seen in a plan view of the layers. Such a structure has a crack-stopping action. If the core is removed, the weight of the strand profile is reduced further. If the core remains, this can stabilize the strand profile.

The second layer structure may be formed with more fibers than the first layer structure. Correspondingly, more fibers that can be subjected to tensile loading are provided than fibers that can be subjected to compressive loading. This may be realized by virtue of the second layer structure comprising more layers than the first layer structure, wherein the number of fibers per layer is identical. Alternatively, it is however also possible for the number of fibers per layer, and/or the fiber volume fraction per layer, to be varied in targeted fashion. By means of such a structure, the strand profile can be subjected to more intense torsional loading. In other words, by means of such a structure, the crack formation limit is shifted toward higher torsional loads.

The number of fibers of the second multiplicity of layers may be greater by a factor of 1.5 to 9, preferably 1.5 to 4, particularly preferably 2 to 3, than the number of fibers of the first multiplicity of layers. In this way, a strand profile which can be subjected to particularly high torsional loading is provided.

The first multiplicity of layers and the second multiplicity of layers may be formed with different fiber volume fractions, wherein the first multiplicity of layers has a fiber volume fraction of 40% to 70% in relation to the volume of the first layer structure, wherein the second multiplicity of layers has a fiber volume fraction of 35% to 60% in relation to the volume of the second layer structure. Within the first and second multiplicity of layers, the fiber volume fraction may likewise be varied slightly in order to coordinate the load-bearing share of individual layers with respect to one another.

The fibers of the first multiplicity of layers may be embedded into a first matrix material, and the fibers of the second multiplicity of layers may be embedded into a second matrix material. Here, the second matrix material may differ from the first matrix material. The first matrix material may have a high strength with a tensile modulus of greater than 2.9 GPa, and the second matrix material may exhibit high ductility.

The fibers of the first multiplicity of layers and the fibers of the second multiplicity of layers may be impregnated with different impregnating agents if the first layer structure is separated from the second layer structure by a layer which is impermeable to the impregnating agents. Such a layer has a crack-stopping action, such that a possible crack in the first layer structure cannot propagate to the second layer structure and vice versa.

The fibers of the second layer structure may be formed as rovings with a filament diameter smaller than a filament diameter of the fibers of the first layer structure.

The core may be an arrangement of twisted fibers, a solid core, an encased solid core, a hollow core or an encased hollow core. It is thus basically possible for numerous types of cores to be used in the context of the present invention. Here, the cross section of the strand profile is preferably circular, though may basically be oval, elliptical, polygonal or polygonal with rounded corners. A hollow core reduces the weight in relation to a solid core.

The first layer structure may be composed of the first multiplicity of layers, and the second layer structure may be composed of the second multiplicity of layers. A strand profile with particularly good fatigue strength is thus specified.

The fibers of the first layer structure and/or the fibers of the second layer structure may be arranged by means of filament winding or by means of pull winding. The fibers can thus be arranged in a particularly exactly oriented manner.

The process may furthermore comprise bending the strand profile. A greater variety of forms is thus attained.

The process may furthermore comprise bending the strand profile into the form of a helical spring. Such a type of helical spring exhibits high fatigue strength and is of considerably lower weight than helical springs composed of steel.

The helical spring may have at least a pitch H, a spring diameter D and a pitch angle α, a ratio tan α=H/(π*D) being not greater than 0.22 and preferably not greater than 0.21. Such a specific geometry has proven to exhibit particularly good fatigue strength.

The strand profile may be designed as a right-handed compression spring or left-handed tension spring, the longitudinal extent directions of the fibers of the first multiplicity of layers being in a right-handed orientation with respect to the longitudinal extent direction of the strand profile at an angle with a magnitude in a range from 40° to 50°, the longitudinal extent directions of the fibers of the second multiplicity of layers being in a left-handed orientation with respect to the longitudinal extent direction of the strand profile at an angle with a magnitude in a range from 40° to 50°. This form of the fibers in the first and in the second multiplicity of layers has proven to be particularly effectively subjectable to torsional loading.

Alternatively, the strand profile may be designed as a left-handed compression spring or right-handed tension spring, the longitudinal extent directions of the fibers of the first multiplicity of layers being in a left-handed orientation with respect to the longitudinal extent direction of the strand profile at an angle with a magnitude in a range from 40° to 50°, the longitudinal extent directions of the fibers of the second multiplicity of layers being in a right-handed orientation with respect to the longitudinal extent direction of the strand profile at an angle with a magnitude in a range from 40° to 50°. This form of the fibers in the first and in the second multiplicity of layers has proven to be particularly effectively subjectable to torsional loading.

The fibers of the first multiplicity of layers and the fibers of the second multiplicity of layers are preferably glass fibers. Such fibers are particularly easy to process and enduringly stable, and have a high fatigue strength.

According to the invention, a strand profile is proposed which is obtained or obtainable in accordance with one of the above-described processes. The strand profile can thus be produced with the above-described advantages of the process.

According to the invention, the use of an above-described strand profile as a spring in a running gear of a motor vehicle is proposed. It is thus possible, in the motor vehicle, for a spring to be used which is of relatively low weight and is nevertheless operationally reliable.

The invention will be discussed in more detail below with reference to the drawings. The drawings are to be understood as diagrammatic illustrations. They do not constitute a limitation of the invention, for example with regard to specific dimensions or design versions.

In the drawings:

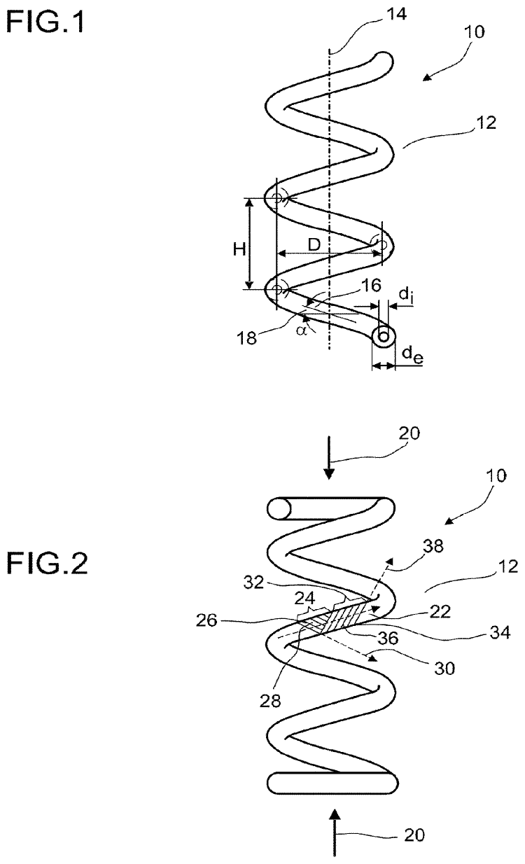

FIG. 1 shows a side view of a strand profile,

FIG. 2 shows a side view of a strand profile according to a first embodiment,

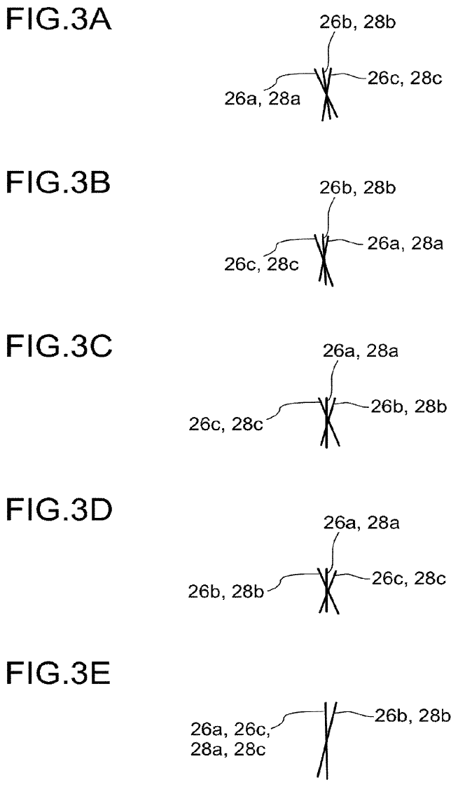

FIGS. 3A to 3E each show a plan view of the first layer structure and examples of possible orientations of the fibers of the first layer structure,

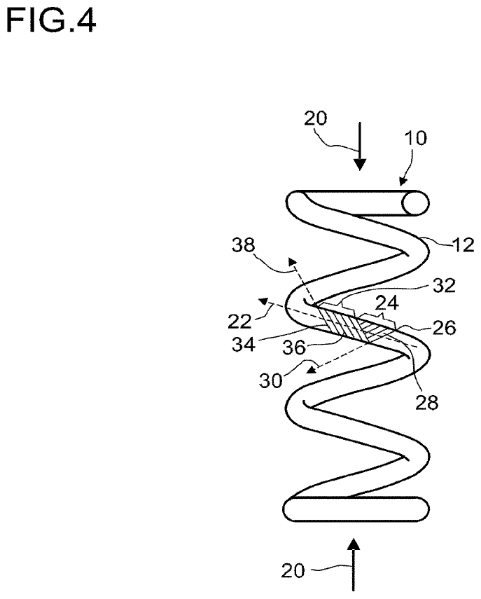

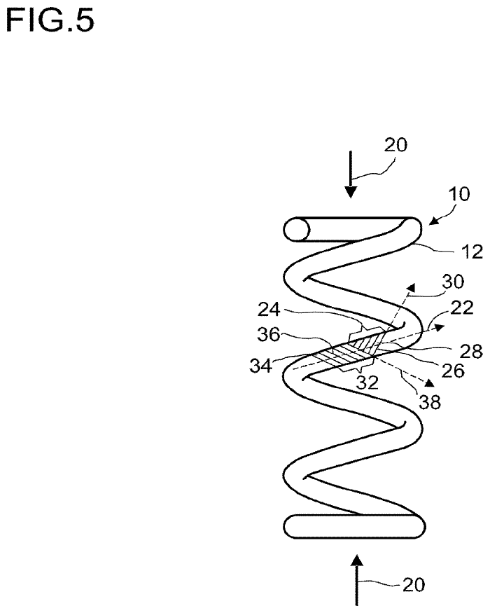

FIG. 4 shows a side view of a strand profile according to a second embodiment,

FIG. 5 shows a side view of a strand profile according to a third embodiment,

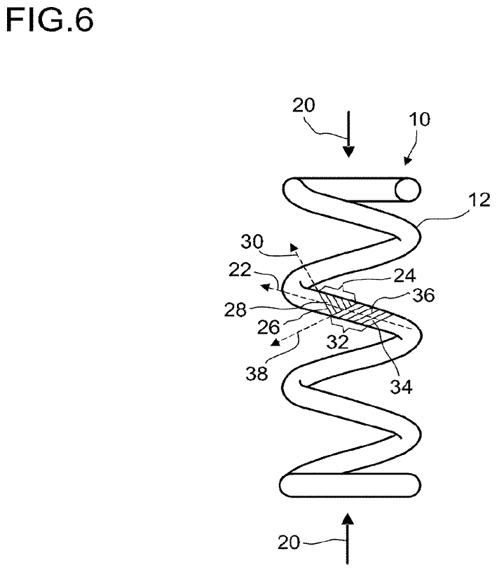

FIG. 6 shows a side view of a strand profile according to a fourth embodiment,

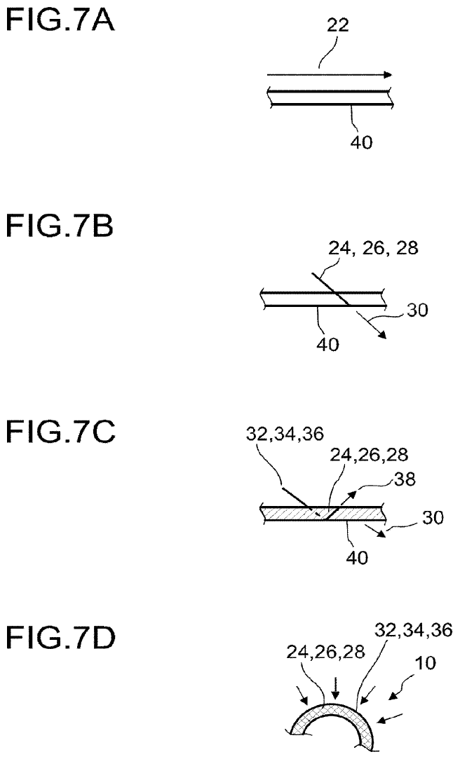

FIGS. 7A to 7D show different steps of a process for producing a strand profile,

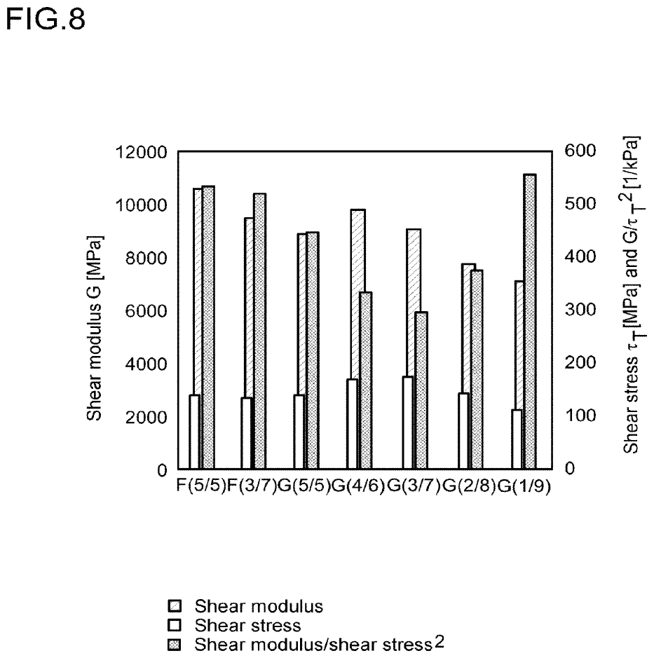

FIG. 8 shows results for the shear modulus, the shear strength and the ratio of shear modulus to the square of the shear strength,

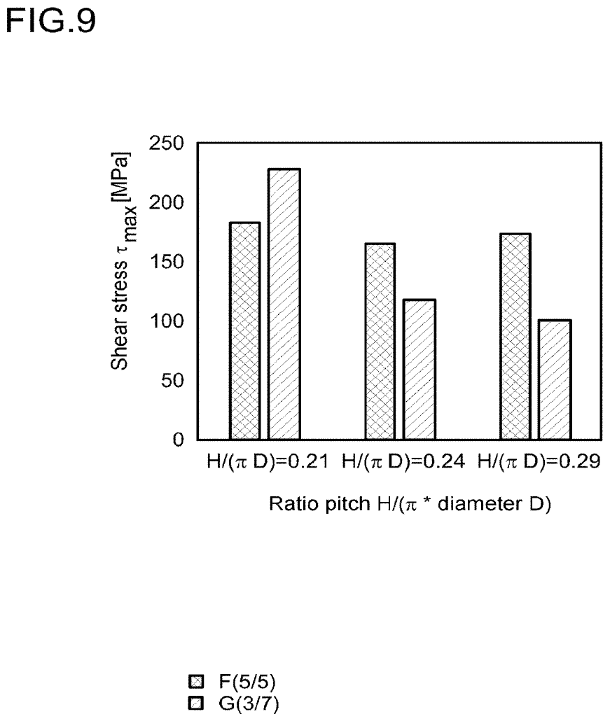

FIG. 9 shows the endurable shear stress τₘₐₓ as a function of tan α and

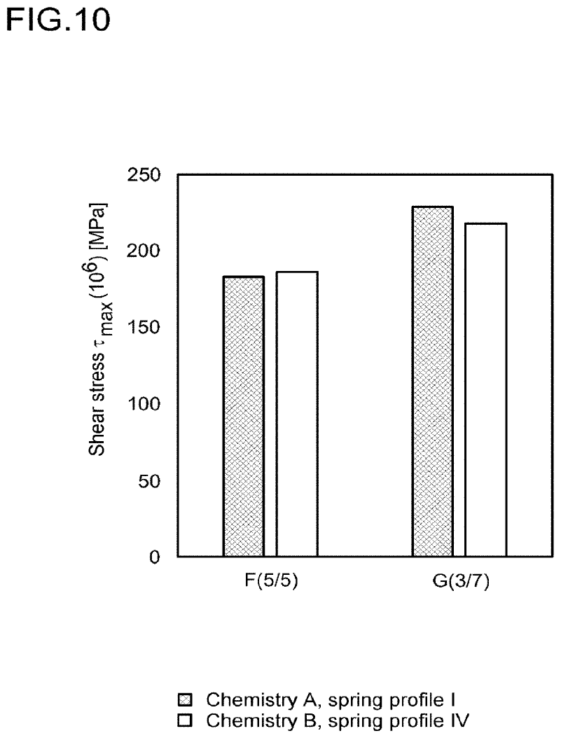

FIG. 10 shows the endurable shear stress τₘₐₓ for two laminate types in springs with similar profile and different chemistry for the materials used.

### DETAILED DESCRIPTION OF THE EMBODIMENTS

FIG. 1 shows a side view of a strand profile 10 which is bent into the form of a right-handed helical spring 12. Correspondingly, the strand profile 10 is wound in right-handed fashion about an axis of symmetry 14. For the purposes of explanation, certain parameters of the helical spring 12 are indicated in FIG. 1. The helical spring 12 has an outer diameter dₑ of the strand profile 10. The strand profile 10 may be of tubular form and may thus have an inner diameter dᵢ. The helical spring 12 furthermore has a pitch H, a spring diameter D and a pitch angle α. Here, the pitch H is defined as the spacing of central points of adjacent windings in a direction parallel to the axis of symmetry 14. Here, spring diameter D is defined as the spacing of central points of adjacent windings in a direction perpendicular to the axis of symmetry 14. The pitch angle α is defined as the angle between a centerline 16 of the strand profile 10 and a plane 18 perpendicular to the axis of symmetry 14.

FIG. 2 shows a side view of a strand profile 10 according to a first embodiment of the present invention. The strand profile 10 is bent into the form of a right-handed helical spring 12. The helical spring 12 has a pitch H, a spring diameter D and a pitch angle α, a ratio tan α=H/(π*D) being not greater than 0.22 and preferably not greater than 0.21. The helical spring 12 is a right-handed compression spring, as indicated by arrows 20. The strand profile 10 extends in a longitudinal extent direction 22. The strand profile 10 has a first layer structure 24 arranged around the longitudinal extent direction 22. The first layer structure 24 has a first multiplicity of layers 26, of which only one is indicated in FIG. 2. The first layer structure 24 is preferably composed of the first multiplicity of layers 26. Each layer 26 of the first layer structure 24 has multiple fibers 28. The fibers 28 of the first multiplicity of layers 26 extend in each case in longitudinal extent directions 30. The longitudinal extent directions 30 of the fibers 28 of the first multiplicity of layers 26 are each oriented at an angle with a magnitude in a range from 30° to 60°, and preferably in a range from 40° to 50°, with respect to the longitudinal extent direction 22 of the strand profile 10. The fibers 28 of the first multiplicity of layers 26 extend relative to the longitudinal extent direction 22 of the strand profile 10 in such a way that, in the presence of setpoint torsional loading of the strand profile 10, said fibers are subjected to longitudinal compressive loading in their longitudinal extent directions 30. In the first embodiment, the longitudinal extent directions 30 of the fibers 28 of the first multiplicity of layers 26 are oriented in right-handed fashion at an angle with a magnitude in a range from 40° to 50° with respect to the longitudinal extent direction 22 of the strand profile 10.

The strand profile 10 furthermore has a second layer structure 32 surrounding the first layer structure 24. The second layer structure 32 has a second multiplicity of layers 34, of which only one is indicated in FIG. 2. The second layer structure 32 is preferably composed of the second multiplicity of layers 34. Each layer 34 of the second layer structure 32 has multiple fibers 36. The fibers 36 of the second multiplicity of layers 34 extend in each case in longitudinal extent directions 38. The longitudinal extent directions 38 of the fibers 36 of the second multiplicity of layers 34 are each oriented at an angle with a magnitude in a range from 30° to 60°, and preferably in a range from 40° to 50°, with respect to the longitudinal extent direction 22 of the strand profile 10. The fibers 36 of the second multiplicity of layers 34 extend relative to the longitudinal extent direction 22 of the strand profile 10 in such a way that, in the presence of setpoint torsional loading of the strand profile 10, said fibers are subjected to longitudinal tensile loading in their longitudinal extent directions 38. In the first embodiment, the longitudinal extent directions 38 of the fibers 36 of the second multiplicity of layers 34 are oriented in left-handed fashion at an angle with a magnitude in a range from 40° to 50° with respect to the longitudinal extent direction 22 of the strand profile 22.

The fibers 28 of the first multiplicity of layers 26 and the fibers 36 of the second multiplicity of layers 34 are glass fibers. The second layer structure 32 comprises more fibers 36 than the first layer structure 24. For example, the number of fibers 36 of the second multiplicity of layers 34 is greater by a factor of 1.5 to 9, preferably 1.5 to 4, particularly preferably 2 to 3, than the number of fibers 28 of the first multiplicity of layers 26. The first multiplicity of layers 26 and the second multiplicity of layers 34 may have different fiber volume fractions. For example, the first multiplicity of layers 34 has a fiber volume fraction of 50% to 70% in relation to the volume of the first layer structure 24, and the second multiplicity of layers 34 has a fiber volume fraction of 35% to 60% in relation to the volume of the second layer structure 32. The fibers 28 of the first multiplicity of layers 26 may be embedded into a first matrix material. The fibers 36 of the second multiplicity of layers 34 may be embedded into a second matrix material. The second matrix material optionally differs from the first matrix material. In the case of different matrix material, the first matrix material has a high strength with a tensile modulus of preferably greater than 2.9 GPa, and the second matrix material exhibits high ductility. The fibers 28 of the first multiplicity of layers 26 are impregnated with a first impregnating agent, and the fibers 36 of the second multiplicity of layers 34 are impregnated with a second impregnating agent. The first layer structure 24 is optionally separated from the second layer structure 32 by a layer which is impermeable to the first impregnating agent and the second impregnating agent. The first impregnating agent differs from the second impregnating agent. The fibers 36 of the second layer structure 32 are formed as rovings with a filament diameter which is optionally smaller than a filament diameter of the fibers 28 of the first layer structure 24. The strand profile 10 may optionally have a core on which the first layer structure 24 is arranged. The core may be an arrangement of twisted fibers, a solid core, an encased solid core, a hollow core or an encased hollow core. The core may remain in the finished workpiece or else may be removed.

In the strand profile 10, the longitudinal extent directions 30 of the fibers 28 of adjacent layers 26 of the first multiplicity of layers 26 differ from one another by an angle with a magnitude in a range from 0° to 10°, preferably 2° to 10° and even more preferably 2° to 6°. Furthermore, the longitudinal extent directions 38 of the fibers 36 of adjacent layers 34 of the second multiplicity of layers 34 differ from one another by an angle with a magnitude in a range from 0° to 10°, preferably 2° to 10° and even more preferably 2° to 6°. This will be discussed in more detail below on the basis of the first layer structure 24, wherein the explanations apply analogously to the second layer structure 32.

FIGS. 3A to 3E each show a plan view of the first layer structure 24 and examples of possible orientations of the fibers 28 of the first layer structure 24. Merely by way of example, a first layer 26a, a second layer 26b and a third layer 26c of the first layer structure 24 are shown, which are arranged one on top of the other in the stated sequence. The first layer 26a has a first multiplicity of fibers 28a. The second layer 26b has a second multiplicity of fibers 28b. The third layer 26c has a third multiplicity of fibers 28c. Of the fibers 28a, 28b, 28c, in each case only one is illustrated for the sake of clarity. Alternatively, in the case of only two layers, the fibers 28a and 28c may vary about an imaginary line of symmetry which has the profile of the fiber 28b.

In FIG. 3A, the second multiplicity of fibers 28b extends at an angle of 0° to 10°, preferably 2° to 10° and more preferably 2° to 6° clockwise as viewed in relation to the first multiplicity of fibers 28a. Furthermore, the third multiplicity of fibers 28c extends at an angle of 0° to 10°, preferably 2° to 10° and more preferably 2° to 6° clockwise as viewed in relation to the second multiplicity of fibers 28b.

In FIG. 3B, the second multiplicity of fibers 28b extends at an angle of 0° to 10°, preferably 2° to 10° and more preferably 2° to 6° counterclockwise as viewed in relation to the first multiplicity of fibers 28a. Furthermore, the third multiplicity of fibers 28c extends at an angle of 0° to 10°, preferably 2° to 10° and more preferably 2° to 6° counterclockwise as viewed in relation to the second multiplicity of fibers 28b.

In FIG. 3C, the second multiplicity of fibers 28b extends at an angle of 0° to 10°, preferably 2° to 10° and more preferably 2° to 6° clockwise as viewed in relation to the first multiplicity of fibers 28a. Furthermore, the third multiplicity of fibers 28c extends at an angle of 0° to 10°, preferably 2° to 10° and more preferably 2° to 6° counterclockwise as viewed in relation to the first multiplicity of fibers 28a.

In FIG. 3D, the second multiplicity of fibers 28b extends at an angle of 0° to 10°, preferably 2° to 10° and more preferably 2° to 6° counterclockwise as viewed in relation to the first multiplicity of fibers 28a. Furthermore, the third multiplicity of fibers 28c extends at an angle of 0° to 10°, preferably 2° to 10° and more preferably 2° to 6° clockwise as viewed in relation to the first multiplicity of fibers 28a.

It is self-evident that the respective angles need not be identical in magnitude.

FIG. 3E shows an arrangement in which, in each case, the fibers 28a, 28c of every second layer 26a, 26c of the same layer structure 24 extend parallel to one another. Correspondingly, the fibers 28a, 28c overlap in the plan view of FIG. 3E.

FIG. 4 shows a side view of a strand profile 10 according to a second embodiment of the present invention. Only the differences in relation to the first embodiment will be described below, and identical components are denoted by the same reference designations. The strand profile 10 is bent into the form of a left-handed helical spring 12. The helical spring 12 is a left-handed compression spring, as indicated by arrows 20. In the second embodiment, the longitudinal extent directions 30 of the fibers 28 of the first multiplicity of layers 26 are oriented in left-handed fashion at an angle with a magnitude in a range from 40° to 50° with respect to the longitudinal extent direction 22 of the strand profile 10. Furthermore, in the second embodiment, the longitudinal extent directions 38 of the fibers 36 of the second multiplicity of layers 34 are oriented in right-handed fashion at an angle with a magnitude in a range from 40° to 50° with respect to the longitudinal extent direction 22 of the strand profile 22.

FIG. 5 shows a side view of a strand profile 10 according to a third embodiment of the present invention. Only the differences in relation to the first embodiment will be described below, and identical components are denoted by the same reference designations. The strand profile 10 is bent into the form of a right-handed helical spring 12. The helical spring 12 is a right-handed tension spring, as indicated by arrows 20. In the third embodiment, the longitudinal extent directions 30 of the fibers 28 of the first multiplicity of layers 26 are oriented in left-handed fashion at an angle with a magnitude in a range from 40° to 50° with respect to the longitudinal extent direction 22 of the strand profile 10. Furthermore, in the third embodiment, the longitudinal extent directions 38 of the fibers 36 of the second multiplicity of layers 34 are oriented in right-handed fashion at an angle with a magnitude in a range from 40° to 50° with respect to the longitudinal extent direction 22 of the strand profile 22.

FIG. 6 shows a side view of a strand profile 10 according to a fourth embodiment of the present invention. Only the differences in relation to the first embodiment will be described below, and identical components are denoted by the same reference designations. The strand profile 10 is bent into the form of a left-handed helical spring 12. The helical spring 12 is a left-handed tension spring, as indicated by arrows 20. In the fourth embodiment, the longitudinal extent directions 30 of the fibers 28 of the first multiplicity of layers 26 are oriented in right-handed fashion at an angle with a magnitude in a range from 40° to 50° with respect to the longitudinal extent direction 22 of the strand profile 10. Furthermore, in the fourth embodiment, the longitudinal extent directions 38 of the fibers 36 of the second multiplicity of layers 34 are oriented in left-handed fashion at an angle with a magnitude in a range from 40° to 50° with respect to the longitudinal extent direction 22 of the strand profile 22.

A process for producing a strand profile 10 will be described below. Here, the process will be described with reference to production of a strand profile 10 according to the first embodiment. The process is however likewise suitable for the production of a strand profile according to the second to fourth embodiments.

Here, FIGS. 7A to 7D show different steps of the process. As shown in FIG. 7A, a core 40 is firstly provided. In order to define the longitudinal extent direction 22 of the strand profile 10, the core 40 extends in a longitudinal extent direction. The core 40 extends for example in straight fashion. The core 40 may be an arrangement of twisted fibers, a solid core, an encased solid core, a hollow core or an encased hollow core. As shown in FIG. 7B, the first layer structure 24 is arranged on the core 40 around the longitudinal extent direction 22. The first layer structure 24 has the first multiplicity of layers 26. The first layer structure 24 is preferably composed of the first multiplicity of layers 26. Each layer 26 of the first layer structure 24 has multiple fibers 28, of which only one is illustrated in FIG. 7B. The fibers 28 may for example be arranged on the core 40 by means of filament winding. The fibers 28 of the first multiplicity of layers 26 extend in each case in longitudinal extent directions 30. The longitudinal extent directions 30 of the fibers 28 of the first multiplicity of layers 26 are each oriented at an angle with a magnitude in a range from 30° to 60°, and preferably in a range from 40° to 50°, with respect to the longitudinal extent direction 22 of the strand profile 10. The fibers 28 of the first multiplicity of layers 26 extend relative to the longitudinal extent direction 22 of the strand profile 10 in such a way that, in the presence of setpoint torsional loading of the strand profile 10, said fibers are subjected to longitudinal compressive loading in their longitudinal extent directions 30. In the embodiment shown, the longitudinal extent directions 30 of the fibers 28 of the first multiplicity of layers 26 are oriented in right-handed fashion at an angle with a magnitude in a range from 40° to 50° with respect to the longitudinal extent direction 22 of the strand profile 10.

As shown in FIG. 7C, the second layer structure 32 is arranged on the first layer structure 24 so as to surround the latter. The second layer structure 32 has the second multiplicity of layers 34. The second layer structure 32 is preferably composed of the second multiplicity of layers 34. Each layer 34 of the second layer structure 32 has multiple fibers 36, of which only one is illustrated in FIG. 7C. The fibers 36 may for example be arranged on the first layer structure 24 by means of filament winding or pull winding. The fibers 36 of the second multiplicity of layers 34 extend in each case in longitudinal extent directions 38. The longitudinal extent directions 38 of the fibers 36 of the second multiplicity of layers 34 are each oriented at an angle with a magnitude in a range from 30° to 60°, and preferably in a range from 40° to 50°, with respect to the longitudinal extent direction 22 of the strand profile 10. The fibers 36 of the second multiplicity of layers 34 extend relative to the longitudinal extent direction 22 of the strand profile 10 in such a way that, in the presence of setpoint torsional loading of the strand profile 10, said fibers are subjected to longitudinal tensile loading in their longitudinal extent directions 38. In the first embodiment, the longitudinal extent directions 38 of the fibers 36 of the second multiplicity of layers 34 are oriented in left-handed fashion at an angle with a magnitude in a range from 40° to 50° with respect to the longitudinal extent direction 22 of the strand profile 22.

The fibers 28 of the first multiplicity of layers 26 and the fibers 36 of the second multiplicity of layers 34 are glass fibers. The second layer structure 32 comprises more fibers 36 than the first layer structure 24. For example, the number of fibers 36 of the second multiplicity of layers 34 is greater by a factor of 1.5 to 9, preferably 1.5 to 4, particularly preferably 2 to 3, than the number of fibers 28 of the first multiplicity of layers 26. The first multiplicity of layers 26 and the second multiplicity of layers 34 may have different fiber volume fractions. For example, the first multiplicity of layers 34 has a fiber volume fraction of 40% to 70% in relation to the volume of the first layer structure 24, and the second multiplicity of layers 34 has a fiber volume fraction of 35% to 60% in relation to the volume of the second layer structure 32. The fibers 28 of the first multiplicity of layers 26 are embedded into a first matrix material. The fibers 36 of the second multiplicity of layers 34 are embedded into a second matrix material. The second matrix material may differ from the first matrix material. For example, the first matrix material may have a high stiffness, and the second matrix material may exhibit high ductility. The fibers 28 of the first multiplicity of layers 26 and the fibers 36 of the second multiplicity of layers 34 are each impregnated with an impregnating agent. The first layer structure 24 may be separated from the second layer structure 32 by a layer which is impermeable to the impregnating agents. The impregnating agents may differ from one another. The fibers 36 of the second layer structure 32 are formed as rovings with a filament diameter which may be smaller than a filament diameter of the fibers 28 of the first layer structure 24.

In the strand profile 10, the longitudinal extent directions 30 of the fibers 28 of adjacent layers 26 of the first multiplicity of layers 26 differ from one another by an angle with a magnitude in a range from 0° to 10°, preferably 2° to 10° and even more preferably 2° to 6°. Furthermore, the longitudinal extent directions 38 of the fibers 36 of adjacent layers 34 of the second multiplicity of layers 34 differ from one another by an angle with a magnitude in a range from 0° to 10°, preferably 2° to 10° and even more preferably 2° to 6°, as described above. The core 40 may subsequently be removed or may remain in the first layer structure 24. A removal of the core 40 is for example possible if the core 40 is produced from PTFE, because this material does not adhesively bond to the matrix system of the fiber composite material.

As shown in FIG. 7D, the strand profile 10 is subsequently bent. The strand profile 10 is for example bent into the form of a right-handed helical spring 12, for example by means of a free-form tool. The helical spring 12 is formed with a pitch H, a spring diameter D and a pitch angle α, a ratio tan α=H/(π*D) being not greater than 0.22 and preferably not greater than 0.21. The helical spring 12 is subsequently cured, which may be performed with a supply of heat.

### EXAMPLES

The present invention will be discussed in more detail on the basis of the following examples.

For the examples below, the following nomenclature will be used, which was used in the determination of the test results.
B Exponent fatigue strength
C Ratio D/dₑ
dₑ Strand profile outer diameter
dᵢ Strand profile inner diameter
D Spring diameter
F Force
G Shear modulus, averaged
H Pitch of the spring winding
k Ratio dᵢ/dₑ
K Spring constant
n Number of oscillations until failure
N Number of spring windings
α Pitch angle of the spring winding
δ Deflection of the spring from the unloaded position
σ_{B,max} Bending stress at the horizontal outer edge of the strand profile cross section
T_{S} Shear stress resulting from shear
T_{T} Shear stress resulting from torsion at the strand profile circumference in the case of radially increasing stress
τₘₐₓ Increased shear stress at the inner circumference of a thick spring owing to torsion and shear, calculated in accordance with Waals
ρ Density

For the geometry of the helical spring, the following ratio applies between pitch H, spring diameter D and pitch angle α:

$$tan ( α ) = \frac{H}{π D}$$

As can be gathered from the standard literature relating to the design of helical springs, stresses resulting from torsion, bending and shear act on the cross section of a hollow helical spring when an axial force is introduced.

Shear stress:

$${τ}_{S} = \frac{4 F}{π ( {d}_{e}^{2} - {d}_{i}^{2} )}$$

Bending stress about the spring axis:

$${σ}_{B , max} = \frac{16 FD sin ( α )}{π {d}_{e}^{3} ( 1 - {k}^{4} )}$$

Shear stress resulting from torsion at the outer edge in the case of a radial stress profile:

$${τ}_{T} = \frac{8 FD}{π {d}_{e}^{3} ( 1 - {k}^{4} )}$$

In the case of springs composed of thick bars or strand profiles, there is a resulting increased shear stress at the inner circumference of the spring winding owing to torsion and shear, which, according to Waals, is approximated by:

$${τ}_{max} = \frac{8 FD}{π {d}_{e}^{3} ( 1 - {k}^{4} )} ( \frac{4 C - 1}{4 C - 4} + \frac{0.615}{C} )$$

Tests relating to fatigue strength are often depicted as Wöhler curves in accordance with the following equation:

$$τ ( {10}^{6} ) = τ ( n ) {( \frac{n}{{10}^{6}} )}^{B}$$

The deflection of the spring is calculated as

$$δ = \frac{8 {FD}^{3} N}{{Gd}_{e}^{4} ( 1 - {k}^{4} )}$$

The spring constant is the local gradient of the force as a function of the deflection:

$$K = \frac{Δ F}{Δδ}$$

Conversely, the required shear modulus can be determined from the gradient:

$$G = K \frac{8 {D}^{3} N}{{d}_{e}^{4} ( 1 - {k}^{4} )}$$

The mass of a helical spring is determined from the demands on the admissible force and desired deflection in the presence of said force as a function of the three material parameters of shear modulus, density and shear strength:

$$m = 2 \frac{1}{1 + {k}^{2}} \frac{ρ G}{{τ}_{T}^{2}} F δ$$

In order, to minimize the mass m in the case of a spring, it is necessary to develop laminates, that is to say layer structures, with a low shear modulus G and a high shear strength τ_{T}.

Tests were performed on right-handed helical springs under compression with the dimensions D=99.5 mm, dₑ=19.5 mm, dᵢ=10.0 mm. The pitch was generally shallower at the two ends, as is conventional in the case of helical springs for the field of automotive engineering. Table 1 shows the pitch of the windings during the forming. The pitch of the spring seats is also listed. The pitch H is stated in mm in table 1. In the first row, the numerical values denote winding portions, wherein the numeral 1 indicates one complete winding, or 360°.

TABLE 1

| Winding | | | | | | | tan(α) = |
|---|---|---|---|---|---|---|---|
| (1 ≙ 360°) | | 0- | 0.75- | 1- | 3.5- | 3.75- | Hₘₐₓ/ |
| Pitch H | Seat | 0.75 | 1 | 3.5 | 3.75 | 4.5 | (π *D) |
| Profile I | 20 | 40 | 40-65 | 65 | 65-40 | 40 | 0.21 |
| Profile II | 20 | 40 | 40-75 | 75 | 75-40 | 40 | 0.24 |
| Profile III | 20 | 20 | 20-90 | 90 | 90-20 | 40 | 0.29 |

| | | | |
|---|---|---|---|
| Profile IV | 45 | 64 | 0.21 |

Laminate: The laminate structure of the individual samples was of fine-layered (F) or coarse-layered (G) configuration with different ratios of the fibers subjected to compressive loading in their longitudinal direction to the fibers subjected to tensile loading in their longitudinal direction. Here, fine-layered means an alternating arrangement of the layers of different direction of rotation, and coarse-layered means that firstly a multiplicity of layers with fibers of the same direction of rotation and then a multiplicity of layers with fibers of an opposite or different direction of rotation are applied. In table 2, in the first column, sample variants are specified which have different laminate or layer structures, wherein the laminate or layer structures are specified in the second column. Here, in the first column, between the parentheses, firstly the number of layers subjected to compressive loading and then the number of layers subjected to tensile loading are specified. For example, F(3/7) signifies a fine-layered structure with three layers subjected to compressive loading and seven layers subjected to tensile loading. The exact structure of the layers is specified in the second column, wherein (−) denotes an orientation or an angle relative to the longitudinal extent direction of the strand profile for layers subjected to compressive loading, and (+) denotes an orientation or an angle relative to the longitudinal extent direction of the strand profile for layers subjected to tensile loading.

TABLE 2

| Sample | Laminate structure |
|---|---|
| F(5/5) | [−45, +45, −45, +45, −45, +45, −45, +45, −45, +45] |
| F(3/7) | [−48, +42, +48, −42, +48, +42, −48, +42, +48, +42] |
| G(5/5) | [−48°, −42°, −48°, −42°, −48°], [+42°, +48°, +42°, +48°, +42°] |
| G(4/6) | [−48°, −42°, −48°, −42°], [+48°, +42°, +48°, +42°, +48°, +42°] |
| G(3/7) | [−48°, −42°,−48°], [+42°, +48°, +42°, +48°, +42°, +48°, +42°] |
| G(2/8) | [−48°, −42°], [+48°, +42°, +48°, +42°, +48°, +42°, +48°, +42°] |
| G(1/9) | [−48°], [+42°, +48°, +42°, +48°, +42°, +48°, +42°, +48°, +42°] |

The following materials were used for the tested strand profiles. The glass fiber was a roving with a weight of 2400 g/km (2400 tex). System A was composed of the resin bisphenol-A-diglycidyl ether with 22 wt. % butanediol-diglycidyl ether and the curing agent diethylmethylbenzenediamine in the mixing ratio 100:26. System B was composed of the resin bisphenol-A-diglycidyl ether with 22 wt. % butanediol-diglycidyl ether and the curing agent dicyanamide (56 wt. %)+methylcyclohexyl diamine (26 wt. %)+3,3′-(4-methyl-1,3-phenylene)bis(1,1-dimethylurea), obtainable under the trade name Uron Dyhard UR500, (18 wt. %) in the mixing ratio 100:11. The fiber mass fraction was determined by calculation, from the used quantity of glass material, core material, auxiliary materials and the total weight of the profiles, as 67%+/−2% for system A and as 65%+/−2% for system B.

The spring rods were produced with a filament winding with 8 filaments per layer with a multiple filament eyelet ring. Winding was performed onto a 7-mm steel core, encased by a polyethylene hose with a 10 mm outer diameter and 1 mm wall thickness, which has no significant influence on the strength and stiffness of the springs. The steel core was drawn after the filament winding. The steel bars were wound onto a tube with 80 mm outer diameter. The pitch in the forming process was set by means of spacers. The curing of system A was performed for 2 h at 120° C. and for 5 h at 150° C. The curing of system B was performed for 3 h at 90° C. and for 1 h at 140° C.

The laminates not only had different load capacities but also exhibited different torsional stiffnesses. Therefore, the tests relating to fatigue strength were run from a minimum holding force of 1000 N up to a highest possible force to a point shortly before the spring assumed a block state, which was 3-5 kN depending on the laminate. The frequency was 3.5 1/s. Thus, in the presence of a force F, a number of cycles n until failure was determined.

The parameters for the comparison of the laminates were calculated as follows: From the spring characteristic curve F(δ), the pitch K was determined at a mean deflection of 55 mm. The shear modulus G was determined from this pitch under the assumption that, at this spring deflection, 4 free windings were able to twist.

The highest torsional stress and maximum shear stress at the number of cycles n was determined as:

$${τ}_{T} ( n ) = \frac{8 FD}{π {d}_{e}^{3} ( 1 - {k}^{4} )}$$

$${τ}_{max} ( n ) = \frac{8 FD}{π {d}_{e}^{3} ( 1 - {k}^{4} )} ( \frac{4 C - 1}{4 C - 4} + \frac{0.615}{C} )$$

With an experimentally determined exponent B=0.05, for the comparison of the laminates, the admissible torsional stress and maximum shear stress at 1 million cycles was determined:

$${τ}_{T} ( {10}^{6} ) = {τ}_{T} ( n ) {( \frac{n}{{10}^{6}} )}^{B}$$

$${τ}_{max} ( {10}^{6} ) = {τ}_{max} ( n ) {( \frac{n}{{10}^{6}} )}^{B}$$

FIG. 8 shows the thus determined results for the shear modulus, the endurable shear stress at 1 million cycles and the ratio of shear modulus to the square of the endurable shear stress.

The results in FIG. 8 show the superiority of these laminates under torsional loading. In particular the ratio G/τ_{T}_{²}, which is proportional to the required spring mass, decreases from the value of the fine-layered standard laminate F(5/5) to 55%, which permits a weight saving in relation to said standard laminate of 45%.

With increasing pitch H or increasing pitch angle α, however, the bending stress in the strand profile also increases. The strand profile can no longer be optimized exclusively for torsion. FIG. 9 shows the endurable shear stress τₘₐₓ as a function of tan α. FIG. 9 shows that, in the case of a spring design with a large pitch H, owing to the higher bending stresses, the torsion-optimized laminate performs less effectively.

Table 3 shows the comparison of shear strength and, in part, shear modulus for different laminates for two different epoxy systems.

TABLE 3

| Spring | | | n | T_{T}(n) | Tₘₐₓ(n) | T_{T}(10⁶) | Tₘₐₓ(10⁶) | K | G | G/T_{T}²(10⁶) |
|---|---|---|---|---|---|---|---|---|---|---|
| profile | Chemistry | Laminate | [—] | [MPa] | MPa] | [MPa] | [MPa] | [N/mm] | [GPa] | [1/MPa] |
| IV | B | F(5/5) | 5.66E+03 | 183 | 240 | 142 | 186 | | | |
| IV | B | G(3/7) | 2.46E+06* | >158 | >165 | >208 | >218 | | | |
| III | A | F(5/5) | 1.28E+05 | 148 | 192 | 133 | 174 | | | |
| III | A | G(3/7) | 1.00E+00 | 155 | 202 | 78 | 101 | | | |
| II | A | G(3/7) | 5.00E+00 | 167 | 218 | 91 | 118 | | | |
| 1 | A | F(5/5) | 3.50E+04 | 166 | 217 | 141 | 183 | 45.0 | 10.6 | 0.54 |
| II | A | F(5/5) | 2.73E+03 | 171 | 222 | 127 | 165 | | | |
| I | A | G(3/7) | 5.70E+06* | >161 | >210 | >175 | >229 | 40.0 | 9.1 | <0.30 |
| I | A | G(2/8) | 9.30E+05 | 145 | 189 | 144 | 188 | 34.0 | 7.8 | 0.38 |
| I | A | G(5/5) | 1.05E+06 | 141 | 184 | 141 | 184 | 40.0 | 8.9 | 0.45 |
| I | A | G(4/6) | 5.87E+05 | 175 | 228 | 171 | 222 | 39.0 | 9.8 | 0.34 |
| I | A | G(1/9) | 2.00E+06* | >110 | >143 | >113 | >148 | 30.5 | 7.1 | <0.55 |
| I | A | F(3/7) | 8.94E+04 | 152 | 197 | 135 | 175 | 38.8 | 9.5 | 0.52 |

*Test ended without spring failure

FIG. 10 shows the endurable shear stress τₘₐₓ for two laminate types in springs with similar profile and different chemistry for the materials used. More specifically, FIG. 10 illustrates the endurable shear stress τₘₐₓ for a strand profile in the form of standard laminate F(5/5) produced with the chemistry in accordance with the above-described systems A and B and for a strand profile with a structure G(3/7) according to the invention produced with the chemistry in accordance with the above-described systems A and B. It can be seen from FIG. 10 that the endurable shear stress τₘₐₓ for the strand profile with a structure G(3/7) according to the invention is higher than that for the strand profile in the form of standard laminate F(5/5), wherein the chemistry used has a negligible influence on the endurable shear stress τₘₐₓ. From FIG. 10, it is possible to clearly see the advantageous effect on the endurable shear stress τₘₐₓ owing to the present invention.

1. A strand profile, the strand profile extending in a longitudinal extent direction, the strand profile having a first layer structure arranged around the longitudinal extent direction and a second layer structure surrounding the first layer structure,
the first layer structure comprising a first multiplicity of layers, each layer of the first layer structure having multiple fibers,
the second layer structure comprising a second multiplicity of layers, each layer of the second layer structure having multiple fibers,
the fibers of the first multiplicity of layers and the fibers of the second multiplicity of layers each extending in longitudinal extent directions, the longitudinal extent directions of the fibers of the first multiplicity of layers and the fibers of the second multiplicity of layers each being oriented at an angle with a magnitude in a range from 30° to 60° with respect to the longitudinal extent direction of the strand profile,
the fibers of the first multiplicity of layers extending relative to the longitudinal extent direction of the strand profile in such a way that, in the presence of setpoint torsional loading of the strand profile, said fibers are subjected to longitudinal compressive loading in their longitudinal extent directions,
the fibers of the second multiplicity of layers extending relative to the longitudinal extent direction of the strand profile in such a way that, in the presence of setpoint torsional loading of the strand profile, said fibers are subjected to longitudinal tensile loading in their longitudinal extent directions,
the longitudinal extent directions of the fibers of adjacent layers of the first multiplicity of layers differing from one another by an angle with a magnitude in a range from 0° to 10°,
the longitudinal extent directions of the fibers of adjacent layers of the second multiplicity of layers differing from one another by an angle with a magnitude in a range from 0° to 10°.

2. The strand profile according to claim 1, the second layer structure comprising more fibers than the first layer structure.

3. The strand profile according to claim 1, the fibers of the first multiplicity of layers being impregnated with a first impregnating agent and the fibers of the second multiplicity of layers being impregnated with a second impregnating agent, the first layer structure being separated from the second layer structure by a layer which is impermeable to the first impregnating agent and the second impregnating agent, the first impregnating agent differing from the second impregnating agent.

4. The strand profile according to claim 1, the strand profile having a core on which the first layer structure is arranged, the core being an arrangement of twisted fibers, a solid core, an encased solid core, a hollow core or an encased hollow core.

5. The strand profile according to claim 1, the strand profile being bent into the form of a helical spring, the helical spring having a pitch H, a spring diameter D and a pitch angle α, a ratio tan α=H/(π*D) being not greater than 0.22.

6. The strand profile according to claim 5, the strand profile being in the form of a right-handed compression spring or a left-handed tension spring, the longitudinal extent directions of the fibers of the first multiplicity of layers being in a right-handed orientation with respect to the longitudinal extent direction of the strand profile at an angle with a magnitude in a range from 40° to 50°, the longitudinal extent directions of the fibers of the second multiplicity of layers being in a left-handed orientation with respect to the longitudinal extent direction of the strand profile at an angle with a magnitude in a range from 40° to 50°, or
the strand profile being in the form of a left-handed compression spring or a right-handed tension spring, the longitudinal extent directions of the fibers of the first multiplicity of layers being in a left-handed orientation with respect to the longitudinal extent direction of the strand profile at an angle with a magnitude in a range from 40° to 50°, the longitudinal extent directions of the fibers of the second multiplicity of layers being in a right-handed orientation with respect to the longitudinal extent direction of the strand profile at an angle with a magnitude in a range from 40° to 50°.

7. The strand profile according to claim 1, the fibers of the first multiplicity of layers and the fibers of the second multiplicity of layers being glass fibers.

8. A process for producing the strand profile according to claim 1, comprising:
(i) providing a core which, in order to define a longitudinal extent direction of the strand profile, extends in a longitudinal extent direction,
(ii) arranging a first layer structure around the core, the first layer structure being formed from a first multiplicity of layers, each layer of the first layer structure having multiple fibers,
(iii) arranging a second layer structure around the first layer structure, the second layer structure being formed from a second multiplicity of layers, each layer of the second layer structure having multiple fibers, the fibers of the first multiplicity of layers and the fibers of the second multiplicity of layers each extending in longitudinal extent directions, the longitudinal extent directions of the fibers of the first multiplicity of layers and the fibers of the second multiplicity of layers each being oriented at an angle with a magnitude in a range from 30° to 60° with respect to the longitudinal extent direction of the strand profile, the fibers of the first multiplicity of layers extending relative to the longitudinal extent direction of the strand profile in such a way that, in the presence of setpoint torsional loading of the strand profile, said fibers are subjected to longitudinal compressive loading in their longitudinal extent directions, the fibers of the second multiplicity of layers extending relative to the longitudinal extent direction of the strand profile in such a way that, in the presence of setpoint torsional loading of the strand profile, said fibers are subjected to longitudinal tensile loading in their longitudinal extent directions, the longitudinal extent directions of the fibers of adjacent layers of the first multiplicity of layers differing from one another by an angle with a magnitude in a range from 0° to 10°, the longitudinal extent directions of the fibers of adjacent layers of the second multiplicity of layers differing from one another by an angle with a magnitude in a range from 0° to 10°, and
(iv) removing the core or leaving the core in the first layer structure.

9. The process according to claim 8, the second layer structure being formed with more fibers than the first layer structure.

10. The process according to claim 8, the fibers of the first multiplicity of layers being impregnated with a first impregnating agent and the fibers of the second multiplicity of layers being impregnated with a second impregnating agent, the first layer structure being separated from the second layer structure by a layer which is impermeable to the first impregnating agent and the second impregnating agent, the first impregnating agent differing from the second impregnating agent.

11. The process according to claim 8, further comprising bending the strand profile into the form of a helical spring, the helical spring in particular having a pitch H, a spring diameter D and a pitch angle α, a ratio tan α=H/(π*D) being not greater than 0.22.

12. The process according to claim 11, the strand profile being in the form of a right-handed compression spring or a left-handed tension spring, the longitudinal extent directions of the fibers of the first multiplicity of layers being in a right-handed orientation with respect to the longitudinal extent direction of the strand profile at an angle with a magnitude in a range from 40° to 50°, the longitudinal extent directions of the fibers of the second multiplicity of layers being in a left-handed orientation with respect to the longitudinal extent direction of the strand profile at an angle with a magnitude in a range from 40° to 50°, or
the strand profile being in the form of a left-handed compression spring or a right-handed tension spring, the longitudinal extent directions of the fibers of the first multiplicity of layers being in a left-handed orientation with respect to the longitudinal extent direction of the strand profile at an angle with a magnitude in a range from 40° to 50°, the longitudinal extent directions of the fibers of the second multiplicity of layers being in a right-handed orientation with respect to the longitudinal extent direction of the strand profile at an angle with a magnitude in a range from 40° to 50°.

13. The process according to claim 8, the fibers of the first multiplicity of layers and the fibers of the second multiplicity of layers being glass fibers.

14. A strand profile obtained by the process according to claim 8.

15. A spring comprising the strand profile according to claim 1.
